(19) United States
(12) Patent Application Publication
(10) Pub. No.: US 2015/0199995 A1
(43) Pub. Date: Jul. 16, 2015

(54) MODULAR CONTENT GENERATION, MODIFICATION, AND DELIVERY SYSTEM

(71) Applicant: ModCon IP LLC, Los Angeles, CA (US)

(72) Inventors: Louis Silverstein, Los Angeles, CA (US); Nolan Silverstein, Los Angeles, CA (US)

(73) Assignee: ModCon IP LLC, Los Angeles, CA (US)

(21) Appl. No.: 14/588,238

(22) Filed: Dec. 31, 2014

Related U.S. Application Data
(60) Provisional application No. 61/926,256, filed on Jan. 10, 2014.
(60) Provisional application No. 61/929,984, filed on Jan. 22, 2014.

(51) Int. Cl. G11B 27/10; H04N 21/845; H04N 21/81; H04N 5/76; H04N 21/8541

(52) U.S. Cl. CPC G11B 27/10; H04N 5/7605; H04N 21/8541; H04N 21/812; H04N 21/8133; H04N 21/816; H04N 21/8456

(57) ABSTRACT

Methods and systems produce and render digital video content having individualized or customized product placement at time of production. The system re-defines how product placement is manifested and delivered to content audience members. Specific products from vendors in an output video stream are shown for specific users. There is a degree of granularity, down to single user-level customization for product placement. Essentially, there is a fine-tune matching between a vendor profile and a user. This ability to modularize product placement is done at time of production, while the video is being shot, and immediately broadcasted and rendered on users' devices. Any malleable, non-critical object in a scene is a candidate for product placement and various factors may be used for the customization, such as demographic, geographic, socio-economic and other factors.

### CROSS-REFERENCE TO RELATED APPLICATIONS

This application claims priority under 35 U.S.C. §119(e) to pending U.S. Provisional Application No. 61/926,256, filed Jan. 10, 2014, entitled “MODULAR CONTENT GENERATION, MODIFICATION, AND DELIVERY SYSTEM” by Silverstein et al., hereby incorporated by reference in its entirety.

This application claims priority under 35 U.S.C. §119(e) to pending U.S. Provisional Application No. 61/929,984, filed Jan. 22, 2014, entitled “MODULAR CONTENT GENERATION, MODIFICATION, AND DELIVERY SYSTEM” by Silverstein et al., hereby incorporated by reference in its entirety.

### BACKGROUND OF THE INVENTION

1. Field of the Invention

The present invention relates to computer systems and software for producing digital video content. More specifically, the software is for modularizing and individualizing video content during time of video production and delivering variations of the video content to multiple entities.

2. Description of the Related Art

The motion picture, television and internet broadcast industry and product placement may also illustrate one motivation behind the present invention. Product placement may be described as the practice of placing a product name or logo (often a source identifier) in a scene in a movie, television show or other “content” to be viewed, heard or otherwise perceived or observed. It is done in a way that makes the name, logo, or message visible to the consumer, viewer or listener (the “user”). One important aspect of product placement is that it is done in a manner that does not interfere with the artistic or creative aspect of the video content; nothing critical in the scene is altered, unless there is a specific intention to do so.

Currently, product placement in a movie, television show, or internet broadcast (hereafter “video content”) is nearly always fixed. That is, it cannot be modified once it is made a part of the video content. For example, video content may be created where an actor is drinking from a Pepsi can (which is identifiable by the labeling on the can shown in the scene). Pepsi may or may not have paid to have its can displayed in the scene. Almost always, once that particular soda can is selected to be used in producing content, the resulting video will have a Pepsi can embedded in it; that is, it will be shown in the content for as long as the content exists.

Presently, there are technologies used in sports broadcasting, such as baseball, that utilize a Green Screen Banner behind home plate in televised baseball games. This technology is intended for a broadcast in a specific region and not individualized for personal streams. This technology, currently in use, depends on chroma-key green-screens and tracked camera data to insert new elements into a scene.

As noted, product placement has two important points relevant to the invention: 1) it is fixed (i.e., embedded); and 2) it does not interfere with artistry or creative aspects of the video content. However, presently, there is no system for creating and delivering “modular” product placement. For example, a company buys product placement in a movie, but is not able to change the name of the product based on the region, much less the identity of a specific viewer.

### SUMMARY OF THE INVENTION

In one aspect of the present invention, methods and systems for producing and rendering digital video content having individualized or customized product placement at time of production are described. Although the invention has novelty and utility in various fields, product placement is used as the described embodiment for enablement in the art of digital video production.

The term “product placement” has been used in the motion picture and television industries for decades, and more recently in Internet video content. The present invention re-defines how product placement is manifested and delivered to audience members. One embodiment of the invention enables individualized or customized product placement; that is, showing specific products from vendors in an output video stream for specific users. First, there is a degree of granularity, down to single user-level customization, for product placement. For example, content having a scene showing a laptop may contain a Samsung laptop for users who own Samsung devices, and an Apple laptop for users who own Apple products. Other, less granular variations are possible, such as showing a Starbucks coffee cup to all users in a specific geographical area and another brand of coffee to users in other geographical areas. Essentially, there is a fine-tune matching between a vendor profile and a user.

Second, this ability to modularize product placement is done at time of production, while the video is being shot, and immediately broadcasted and rendered on users' devices. Any malleable, non-critical object in a scene is a candidate for product placement and various factors may be used for the customization, such as demographic, geographic, socio-economic and other factors. There is minimal post-production work required to achieve this customized product placement output stream; post production work is nearly eliminated. Data capture is done during an initialization stage and actual production. The amount of data and the type of data captured and sensed, varying from camera location, sound, lighting, to the on and off scene movement of actors, enable many features of the present invention. A voluminous amount of data is utilized, far more than in conventional production.

Third, as a scene is being shot, the individualization of the video content stream is taking place based on user profiles and their viewing devices. The output stream is transmitted to those devices and rendered therein. Methods and systems of the described embodiment also enable what can be characterized as advanced user data collection. User profiles, including psychological factors and breakdowns, may be updated and shaped based on their reaction to specific product placements and other non-essential and essential elements of a scene, amounting to nearly instant feedback on changes to that scene, as described below.

### BRIEF DESCRIPTION OF THE DRAWINGS

References are made to the accompanying drawings, which form a part of the description and in which are shown, by way of illustration, specific embodiments of the present invention:

FIG. 1 is a flow diagram illustrating a process of creating a 3D rule set in accordance with one embodiment;

FIG. 2 is a block diagram illustrating inputs to a selection algorithm or logic component and resulting multiple output streams to viewers in accordance with one embodiment of the present invention;

FIG. 3 is a flow diagram of what may be described as pre-production followed by production of individualized video content streams in accordance with one embodiment;

FIG. 4 is a flow diagram of a quantum neural feedback predictive and reactive algorithm in accordance with one embodiment; and

FIGS. 5A and 5B are block diagrams of a computing system suitable for implementing various embodiments of the present invention.

### DETAILED DESCRIPTION OF THE INVENTION

Example embodiments of software tools for producing digital video content individualized for specific users are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for producing and rendering digital video content having individualized or customized product placement at time of production are described herein. Although the invention described has novelty and utility in various fields, product placement is used as the described embodiment for enabling the invention to a person of ordinary skill in the art of digital video production.

As described above, the term “product placement” has been used in the motion picture and television industries for decades, and more recently in Internet video content. The present invention re-defines how product placement is manifested and delivered to audience members (“users”). Methods and systems of the present invention enable individualized or customized product placement; that is, showing specific products in the content for specific users. First, there is a degree of granularity, down to user-level customization, for product placement. For example, content having a scene showing a laptop as a prop may contain a Samsung laptop for users who own Samsung devices, and an Apple laptop for users who own Apple products. Other, less granular variations are possible, such as showing a Starbucks coffee cup to all users in a specific geographical area and Peet's coffee cups to users in other geographical areas. Essentially, there is a fine-tune matching between a vendor profile and a user.

Second, this ability to modularize product placement is done at time of production; that is, while the video is being shot, and immediately broadcasted and rendered on users' devices. Any malleable, non-critical object in a scene is a candidate for product placement and various factors may be used for the customization, such as demographic, geographic, socio-economic and other factors. There is minimal post-production work required to achieve this customized product placement output stream; post production work is nearly eliminated. Data capture is done during pre-action (initialization stage) and actual production (principal photography). The amount of data and the type of data captured and sensed, varying from camera location, sound, lighting, to on and off scene movement of actors, enable many features of the present invention. A voluminous amount of data is utilized, far more than in conventional production. Third, as a scene is being shot, the individualization of the video content stream is taking place based on user profiles and their viewing devices (“viewers”). The output stream is transmitted to those devices and rendered therein. Methods and systems of the described embodiment also enable what can be characterized as advanced user data collection. User profiles, including psychological factors and breakdowns, may be updated and shaped based on their reaction to specific product placements and other non-essential and essential elements of a scene, amounting to nearly instant feedback on changes to that scene, as described below.

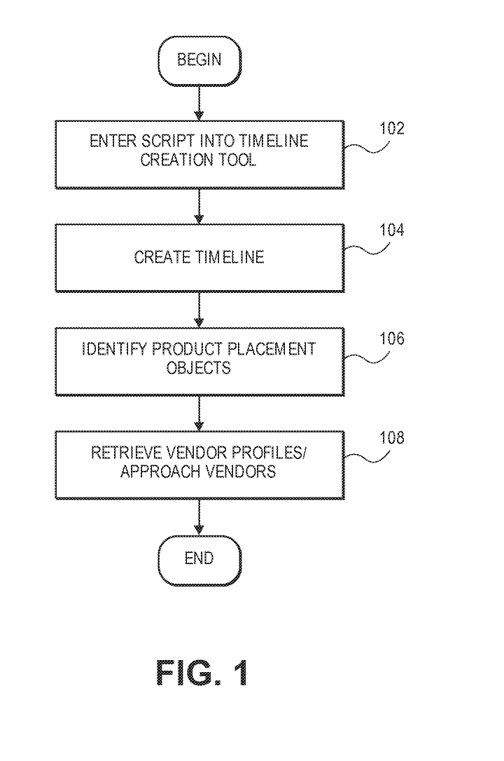

FIG. 1 is a flow diagram illustrating a process of creating a 3D rule set in accordance with one embodiment. This rule set may be described as a collection of timelines also referred to as a world table. It is helpful at the outset to explain that a 3D rule set (world table) typically represents the entire script of a video content. More specifically, it represents all the timeline tables comprising a script. In one embodiment a timeline table represents a scene in a script. When the process in FIG. 1 is complete the system has created a 3D rule set that is used for a subsequent stage referred to as pattern matching correlation. Another phrase used for describing the 3D rule set is vector data (as used in the provisional application).

At step 102 a script for the video is entered into a timeline creation tool, an engine executing on the computing system of the present invention (“system”). In the described embodiment, the video may be any type of content that is suitable for product placement. More broadly, the video may be any content that contains malleable or replaceable objects which may also be described as modular content. Objects may also represent lighting, audio, and other production elements. In the described embodiment, the script will likely be for a television show or motion picture (but is not limited to these content categories) and will in most cases be a comprehensive shooting script and storyboard, typically made up of multiple scenes. It may also be referred to as a production book including description of the environment in which the action and dialogue take place.

At step 104 a timeline is generated for each scene in the script. Timeline tables embody the script and follow a novel syntax comprised of descriptors which are attributes of a wide range of 3D objects. Descriptors essentially instruct the timeline creation tool on how to describe 3D objects in the script. A timeline, a critical component of the present invention, may be described as a relational script that behaves much like an object-oriented programming language. For a given scene a timeline is inserted and stored in the system. It guides the rules and behavior of the object in the subject scene. For example, a simple scene may consist of Sir Isaac Newton sitting under an apple tree. During this scene the content producers want an apple to fall onto his head. For simplicity, it can be assumed that he is a real actor sitting under a real tree but the apple is digital with a foam proxy. Below is a sample script.

Example Script:

EXT. CAMBRIDGE COLLEGE - DAY
Sir. Isaac Newton is sitting under an apple tree. He is enjoying a dreary
English afternoon and sipping on a cup of tea. He has a note book and
is drawing diagrams of different objects.
All of a sudden he hears a cracking sound and an apple falls on his head.
He is dazed for a second and then picks up the apple. He then picks up
his note book and drops them both simultaneously. At that moment a
candle (light bulbs didn't exist yet) in a thought bubble pops over his
head.
End Scene

The scene has several objects: Cambridge College, Newton, Note Book, Quill Pen, Cup of Tea, Apple, Tree, Thought Bubble, and a Candle. A relational understanding of the objects is that Cambridge College is the parent object of Tree and Newton, Tree is the parent object of Apple, and Newton is the parent object of Note Book, Cup of Tea, Thought Bubble, and Candle.

The timeline creation tool of the present invention accepts the script as input and is used to identify each of these objects and their relationships to other objects in the scene. In addition, each of these objects is inserted into the system as a digital element for classification as an object. The code below is an example of how a timeline object is defined worldSIR_ISAAC_NEWTON_EXAMPLE: [36000, #Time_Base int=how long the entire scene runs. The equation for this is, frames (120) * seconds (x) * minuets (n) . . . . In this scene x=60 and n=5. [CAMBRIDGE_COLLEGE, SIR_ISAAC_NEWTON, TREE, APPLE, NOTE_BOOK, Quill_Pen, CUP_OF_TEA, THOUGHT_BUBBLE, CANDLE]]; #THREADS metrix=the THREADS in a time line. THREADS are objects arrays. threadCAMBRIDGE_COLLEGE: [“cambridge college—day”, #Thread Name String (eg. Jack Jimminy, SGI, Corporation of State) #00ff00, #Color_Marker String (eg. #FFFFFF=[White] vs. #FF0000=[RED] −1, #Z_Position int (auto assign unless manually input|“−1=background”) [0, 36000], Time_Range Array of Objects [TimeCode_Start, TimeCode_End] 1, #Importance int [low 0 9 high] [Location], #Location Array of Objects [Location_Code, Scene_Description, Misc], Location_Code String (L#000—(Name_Of_Location)_Address) “External courtyard of Cambridge college with an apple tree in the scene under which Sir Isaac Newton is sitting.” [SIR_ISAAC_NEWTON, TREE] (these are the children of the scene or connected threads), [SFX_ENV] (this is the media loader for the scene, ie sounds, videos, etc that are associated with the scene but not the objects in the scene, mostly this will be part of the objects not the thread), 0 (wildcard_value is not present in this scene, ON (toggle is an on/off switch for this thread).]

In one embodiment, timelines are stored as tables and contain descriptions of all the objects and characters in the script. It provides a chronological listing of all 3D objects appearing in the script. A character, whether animated or live action, in the script is also considered an object. As steps 102 and 104 show, there is a significant amount of data captured, not only in these initial steps, but throughout the process. As noted above, many types of data are captured in the process (pre-production/initialization and production) so that individualized video content can be rendered for specific individuals or demographics.

At step 106 the system identifies modular content or objects in the timeline tables, which can also be characterized as a matrix of files, each file representing one 3D object in the scene. The system determines which 3D objects in the script are candidates for product placement. Guidelines and practices for identifying such objects are known in the art. Generally, objects that are non-essential or not critical to the creativity of the scene are potential candidates. This can be done by examining timeline tables and following conventional practices for identifying product placement opportunities. At this stage the entity producing the video content, or executing the steps described herein, has a clear idea of the product placement opportunities available in the script. In a broader sense, other 3D objects, such as actors or objects that are not conventional product placement candidates, may also be identified. These objects may also be replaced using the processes described below for reasons other than product placement, such as gauging user feedback to different scene environments or performing “localization” of a scene.

At step 108 the entity producing the video content may approach suitable vendors about showing their products in, for example, the TV show or movie. Or, in the described embodiment, examine existing vendor profiles to see if there is a match between what vendors want and what opportunities are available in the script. This step manifests one of the important novel features of the present invention: the high level of granularity in which a video can be individualized for a specific user with respect to product placement. In one embodiment, a vendor has a profile with the system operator. For example, a vendor may be a beverage company (e.g., Pepsi) that is looking for product placement in content that will be watched by men 18-22 with red colored backgrounds or wall and with a subject that is drinking a beverage. As the system is monitoring environmental variables as well as potentially changing these variables, the product placement might be integrated into a scene in a show where the scene already has a red environment or tone and to a user that represents the desired demographic. Or, if it is deemed that the scene coming up can have a red wall the system might alter that wall for male users 18-22 to a scene with red background to place the beverage into that stream. The process of creating a 3D rule set is complete.

The level of control can be further refined by specifying different cues that the vendor would like. For example, a vendor might have a product that is being targeted to a male audience but the product is being shown primarily in a program watched by female users. The current system is not only recording and processing the data from the distributors side, but is also inserting data from the viewer device. As such, the system can sense which user is watching the content. It could place a specified product into the stream even though that product placement opportunity or spot would normally be reserved for a more female audience.

Generally, the profile contains information on what user demographic and characteristics the vendor wants to expose its products to, such as age range, geography, socio-economic class, product preferences (e.g., do they already own a product by the vendor?), content genres or types of shows, time and day of the broadcast, and other factors. It may also store descriptions of which products it wants to have displayed in the content. A vendor profile may instruct that if there is a show or movie that is targeted to males ages 18 to 32 and already own one of our products, we want to buy that product placement opportunity. As noted, the system operator (e.g., the production entity) may also approach new vendors and attempt to sell product placement spots. This is possible because at this stage in step 108 the operator has identified these opportunities and has the information on the content which will be broadcasted. It is the ability to use vendor profiles and user profiles, described below, to individualize the video content with respect to which products are shown, down to the level of the user that separates the product placement processes of the present invention from conventional practices.

In addition, any video content created with the system of the present invention allows for numerous rebroadcast potential with the ability to place new products into the product placement slots or opportunities at any time. For example, a vendor may want the initial broadcast of the content but does not care about subsequent broadcasts (i.e., rebroadcasts) or would only like its products to appear in the content to a smaller number of users after the initial broadcast (showing its initial products). This can be done and allows for future opportunities for other vendors who may see new potential in the user demographic. For example, over time the user base may have changed for some content and the products that are important to those users may also have shifted.

A detailed example of categories, arrays, strings and variables of a vendor profile in the described embodiment are provided below.

```
Vendor: [ ]
ID: str; #REQUIRED KEY
ALIAS: #VENDOR DEFINED and multiple ALIAS could be linked
to the same VENDOR or different VENDOR accounts
COMPANY:[ ]
        LOCAL: [ ]; #Known Linked Vendors
                ID: str[ ]; #REQUIRED KEY
        REMORE: #Known linked remote Vendor profiles
                ID: str[ ]; #REQUIRED KEY
        PRODUCT:[ ]
                ID: str[ ]; #REQUIRED KEY
                MAKE:[ ] company sub name or line
                MODEL: [ ] unit model type
                VERSION: [ ] aka, revision
                DETAILS: [ ] objects related to details of unit
                        MATERIALS: str[ ]; materials list
                        COLORS: str[ ]
                                LIMITED COLORS: material list
                                PREDFINED COLORS: [ ]
                                MATERIALS: [ ]
                                Etc...
                TARGETS:[ ]
                        DEMOGRAPHICS:[ ]
                                AGE:[ ]
                                GENDER:[ ]
                                INTERESTS:[ ]
                                        CLIENT_TYPE:[ ]
                                                CURRENT: bool
                                                RELATED: [ ] IDs
                                        SIMILAR_PRODUCTS:[ ]
                                        IDs
                        SPECIFIC:[ ]
                        REGIONS: [ ] IDS
                        SPECIFICS: [ ]
                        Etc..
                PARTICIPATION:[ ]
                        UNITS:[ ]
                                SEEN:[ ] IDs
                                CLICKED:[ ] IDs
                                PRIMED:[ ] IDs
                        RELATED:[ ]
                        SCRIPTS:[ ]
                        Etc...
CONTACT: [ ]
        USER:[ ] - nested
```

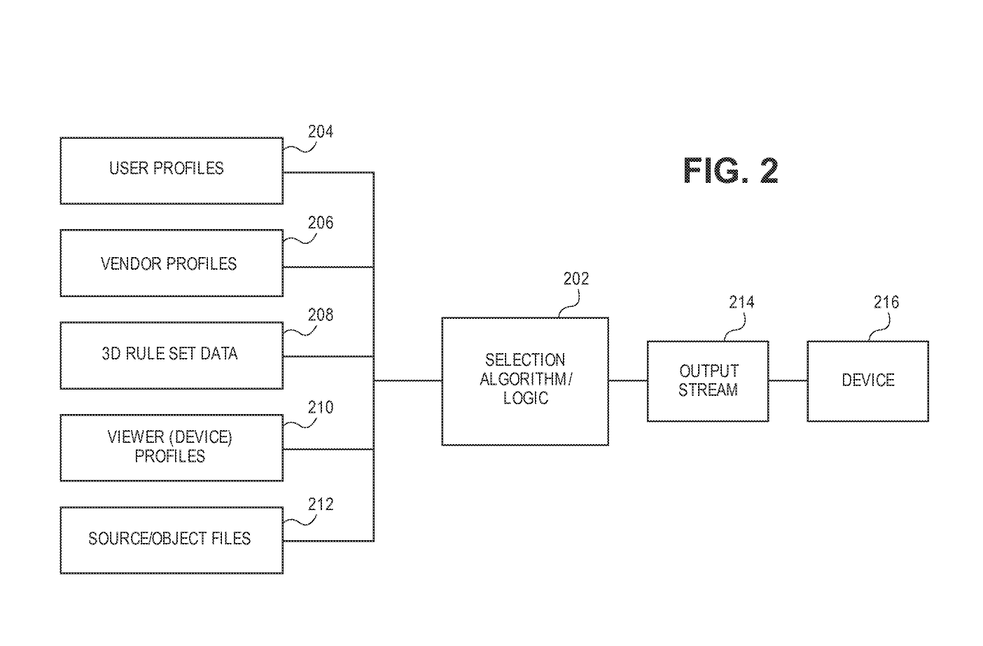

FIG. 2 is a block diagram illustrating inputs to a selection algorithm or logic component and resulting multiple output streams to viewers in accordance with one embodiment of the present invention. There are several inputs to logic component 202, all described above: user profiles 204, vendor profiles 206, 3D rule sets 208, viewer (device) platform data 210 and object source file 212. Logic component 202 examines and uses these data to produce output content streams. In one embodiment, logic 202, implemented as software, may execute on a third-party service provider server or on a computing device operated by the entity producing the video content. Logic 202 determines what to render, that is, what video content to stream to a specific user using a specific viewer. As described above, it outputs an individualized video content stream 214 that is displayed on a viewer 216. There are n number of individualized output streams similar to stream 214 (not shown) created by selection algorithm 202, one for each user or group of users.

At this stage the system has created a world table for the script. The data in this table gives the system a substantially clear picture of what the scenes will look like; a detailed, although generic image, of what the system should expect when production begins. The world table is analogous to an animatic or storyboard for conventional productions, but includes more details about objects that are already known to the system as explained above. Because the system has a detailed chronological listing of the 3D objects in the script, as well as data on environment and, in one embodiment, movements of actors, it is effective for use in pattern matching or correlation during production. It is also useful to note that although one aspect of the 3D rule set is a chronological listing of 3D objects present in all scenes in a script, the objects, characters, production elements, and actions (collectively “objects”) are not tethered to an absolute or exact time scale. Rather, the objects have temporal relationships with each other; the chronological aspect of the 3D rule set is relational and has meaning within the world timeline. The appearance of objects is described in relationship with each other and actions taken by the actors. In one example, timing may be described as “When John enters the room, Joan picks up her glass” or once Sir Issac Newton is focused on his notes, trigger the apple to fall onto his head. A world clock mechanism can be used to synchronize all sensors in the production facility to the world timeline. In addition, the relational data in the 3D rule set does not limit the system to linear production (shooting each scene in order). Rather, as the system keeps track of all scenes and elements, it can allow for non-linear production. As a result, the system is able to automatically recalculate or reconfigure the segments or scenes into the prescribed/linear order for rapid distribution of a finalized broadcast, i.e., automated editorial.

At this stage the world table has been created. The table includes data on the product placement opportunities in the content. Vendors and the products to be shown have been identified. Other data examined include user profiles, that is, who are the individuals watching the content, what do we know about them, and what types of viewers are they using to watch the content (e.g., smart phone, game console, tablet, laptop, HDTV, etc.). In one embodiment, a selection algorithm operates on 3D creation rule set data, object tables, vendor data, user data, and viewer device data to create video content output streams for each user or category of users.

User profiles are stored in a user table and are created using a user creation tool. A profile can be created using conventional methods, such as asking users to complete questionnaires and collecting data from various sources. Profiles may contain a variety of information, such as what the user likes to watch, what types of products he/she owns, who the vendors of those products are, what types of products he/she is interested in, what times/day does he/she watch content, what types of viewers does he/she use. For example, is the user a Pepsi or Coke drinker. Based on this and other user profile information such as age, income, geographic location, and certain proclivities, the system will use this data to match the user with a suitable vendor and vice versa.

A detailed example of categories, arrays, strings and variables of a user profile in the described embodiment are provided below. As noted, a USER: is an Object that is defines an agent of the system.

USER

ID: str; #REQUIRED KEY
ALIAS: [ ]; #USER DEFINED and multiple ALIAS could be linked to the same USER or
different USER accounts (different user accounts are KNOWN but do not influence the current USER)

LOCAL: [ ]; #Known Linked Users of same agent that dynamically influences the
current USER data-set.

ID: str; #REQUIRED KEY
RANK: int; #Based on frequency of access using selected ALIAS

REMOTE: [ ]; #Known linked Users that do not influence the current USER data-set - hidden from

Human View

ID: str; #REQUIRED KEY

NAME: [ ]; #

ACT_LAST: str; #USER's Last Legal Name aka surname
ACT_FIRST: str; #USER's Legal First Name
ACT_MIDDLE: str; #USER's Middle Legal Name
DES_LAST: str; #USER's Desired Last Name aka surname
DES_FIRST: str; #USER's Desired First Name
DES_MIDDLE: str; #USER's Desired Middle Name
EMAIL: [ ];
ADDRESS: [ ];
ALIAS: str; #USER@ domain.com
DOMAIN: str; #USER@domain.com
TYPE: [ ];

PERSONAL: int;
BUSINESS: int;
OTHER: [ ];

DESCRIPTION: str;

| ACTIVITY: [ ]; | |
|---|---|
| a. | ACTIVE: bool; |
| b. | LAST_CONTACTED: str; |
| c. | CREATED: str; |
| d. | UPDATED; str; |

| | |
|---|---|
| b. | INSTANT_MESSAGING: [ ]; |

| | |
|---|---|
| i. | IRC: [ ]; |

| | |
|---|---|
| 1. | ALIAS: str; |

| | |
|---|---|
| ii. | GCHAT: [ ]; |

| | |
|---|---|
| 1. | ALIAS: str; |

| | |
|---|---|
| iii. | AIM: [ ]; |

| | |
|---|---|
| 1. | ALIAS: str; |

| | |
|---|---|
| iv. | SMS: [ ]; |

| | |
|---|---|
| 1. | ALIAS: str; |

| | |
|---|---|
| c. | PHONE: [ ]; |

| | |
|---|---|
| i. | LISTING: [ ]; |

| | |
|---|---|
| 1. | NAME: str; |
| 2. | TYPE: [ ]; |

| | |
|---|---|
| a. | PERSONAL: int; |
| b. | BUSINESS: int; |
| c. | OTHER: [ ]; |

| | |
|---|---|
| i. | DESCRIPTION: str; |

| | |
|---|---|
| 3. | ACTIVITY: [ ]; |

| | |
|---|---|
| a. | ACTIVE: bool; |
| b. | LAST_CONTACTED: str; |
| c. | CREATED: str; |
| d. | UPDATED; str; |

| | |
|---|---|
| 4. | COUNTRY_CODE: int; |
| 5. | AREA_CODE: int; |
| 6. | NUMBER: int; |
| 7. | EXTENSION: int; |

| | |
|---|---|
| d. | DEVICES: [ ]; #information about connected systems/devices |

| | |
|---|---|
| i. | ID; str; #DEVICES have their own profiles and are defined as in device |

| | |
|---|---|
| e. | MAINTENANCE: [ ]; |

| | |
|---|---|
| i. | ACTIVE: bool; |

| | |
|---|---|
| 1. | ACCESS: [ ]; |

| | |
|---|---|
| a. | LOG: [ ]; |

| | |
|---|---|
| i. | LINE:[ ]; |

| | |
|---|---|
| 1. | LAST_ACCESSES: str; |
| 2. | SESSION_DURATION: str; |
| 3. | ALIAS: str; |
| 4. | deviceID: str; |

In one embodiment of the present invention, a profile may contain certain psychological and even physiological data of the user. For example, it may contain data on what objects (e.g., tablets, cars, clothing, etc.) or environmental features (e.g., room colors, hues, design styles, etc.) evoke a physical or emotional reaction in the user. Does the user's heart rate increase when something or certain type of environment is shown? Does the user get visibly excited or upset at certain things? For example, the color pallet of a user's present environment or other environments (stored in the profile) might help drive the content. For example, if the system knows the color of the user's bedroom, it can use the same color in a bedroom scene to evoke a sense of familiarity. The system could even place a character in the user's room if the system had access to that data. The important feature here is that the user profile contains all the information about a user that the system and its operators can ascertain. The location of the user also allows for group experiences. An extreme example of this is the system knowing vendor data (e.g., truck routes and GPS locations of a vehicle) and the location and orientation of a user. For example, if a user is watching a show while at a cafe and there is a product placement opportunity, the system could cue the user to look away from the viewer screen at a passing truck that has the logo of the vendor on it. This would simply take knowing the orientation of the viewer device, the location of the truck, and simple cues that trigger the user to look in a direction.

As noted, user reactions can be examined if a viewer has a front facing camera, in some cases using newly developed 3^{rd} party algorithms (e.g., for determining heart rate from examining a user's chromatic fluctuation over time). This data can be used to evolve and calibrate user and vendor profiles and fine tune the process of finding suitable matches between user and vendor products. This will ultimately result in more effective product placement. The user profile may also have data that indicates at a detailed level what the user's preferences or proclivities are and what the user would like to see. The system is “learning” about the user and building a user-specific set of rules which may be another component of the user profile. For example, not everyone reacts to the same stimuli in the same way. Thus, in one embodiment, the system is continually or occasionally testing new stimuli sets on the user and tracking the results. In conjunction with this the system has a predicted outcome, an inverse outcome, and an observed outcome. Once the actual reaction to the stimuli is observed, the system performs computations and the user profile or model is adjusted or calibrated accordingly.

As is known in the art, product placement in TV shows, movies, and other content is standard practice in the industry. The processes of the present invention make the product placement effective and efficient by determining as closely as possible what products the user would like to see in the content and matches that with what vendors have to offer, on a user-by-user basis. The selection algorithm creates an encoded source stream with metadata for each user. The system examines each user and vendor profile and determines if there is a match. The output stream is then rendered on a known viewer.

In one embodiment, production of the video content begins with capturing all data points, including raster data, 2D data, and 3D data representing objects in the script. The physical stages where production occurs are equipped with sensors so that the electro-magnetic spectrum is captured using as many sensors presently available and integrating new sensors. As such, the sensors are able to capture data related to the objects from different views and spectrums. This is one of the key features which enable the system to basically replace 2D pixels that display an object, such as a cup, with substitute 2D pixels of a different cup having generally the same dimensions. And, furthermore, have this pixel substitution done during production. One of the goals is to identify all or most elements that appear in the production with elements in the object tables referenced in the timeline tables. In one embodiment, this capturing of the 3D object is essentially an initialization of each object. In addition, the initialization includes capturing the range of motion of each actor. This may be described as pre-action or pre-production detailed identification of all the objects in the script.

As noted, this captured identification data is used by the system during production, specifically filming, of the scene. It is not a component of the timeline tables or 3D creation rules data. The system uses this data for correlating what is being shot and what is in the script. In order to perform this pattern matching, it needs to have extensive data on all the objects and actors that appear in the scenes. Once the data capture is complete (which is done on a stage within range of all the sensors), the actual shooting or production can begin.

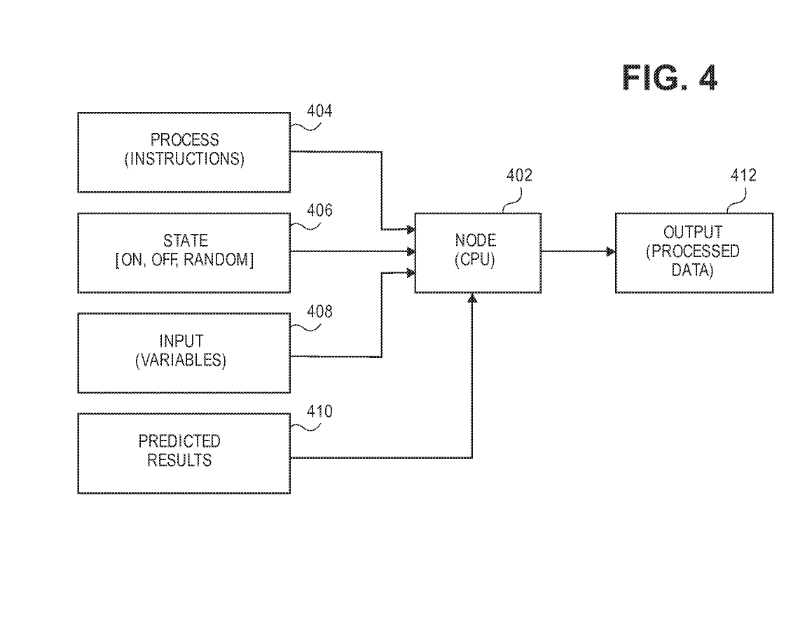

The system is not based on rigid patterns but rather a gradient of information much like a neural type network that uses collections of patterns to define objects as described in more detail in FIG. 4 below. For example, for the system to recognize a banana, it will have an object file for a banana. In order to generate this object file, the system is exposed to banana stimuli. Through 2D video sensors, the system is given examples of the visible spectrum representation of a banana. The values which will be stored in the banana object file gain may be color and some basic shape data. The shapes that can be derived from this (i.e., via 2D video sensors) are what are called silhouette samples. These are used for rapid 2d pattern matching, in other words, searching. The color data will also help narrow the pattern matching or searching. A 3D scan of the banana will give the system a more compete spatial volume (3D point cloud data) to utilize in the matching process. Much like the silhouette sample match, the 3D point cloud data gives the system a 3D data set it can use. This is useful as some 2D patterns might overlap given that many 2D objects look the same to the system. The system does not have a single data set but a matrix of data sets or samples. In one embodiment, every time a new example of the same type of object is recognized, the object is added to the data set. For example, some bananas are different colors and some have different shapes. Thus, the data set will be represented by a spectrum so that objects that hit marks 1, 2, 3, and 4. That is, once the system has a few samples, a bell curve is established. A banana will not always fall on the apex of that curve of data, but may fall on either side, but with the additional data points it will be, within a range, could be deemed a banana. In addition, some help from a thermal sensor and auditory sensors may help identify a given object. As noted, many sensors from the Electro-Magnetic spectrum will be implemented to identify each object. In addition, the system will record all sensor data in an optimized form that will allow for re-broadcast or re-mixing of the sequences, and further allow for n^{x} generations of product placement in future reproductions of the content.

During production, actors perform their parts and the 3D objects are used or appear as instructed in the script. It is helpful to note here that in the described embodiment, the relevant objects are the ones that are candidates for product placement (which may not be all the 3D objects in the scene). When actual production starts, the world/table created in FIG. 1 is initiated, the system starts the timeline, and synchronization begins. The actual shooting is performed concurrently with running the world timeline. Essentially, this tells the system that the first scene is beginning and here is what the system should expect. It replaces the 3D rule set that was created in FIG. 1. At the same time, the director begins shooting scene one. When the system sees a 3D object in the scene, such as a soda can, it is taking in a substantial amount of data from all the sensors. Of course, the sensors also detect a significant amount of noise or data that is not relevant. It needs to be able to know what a relevant 3D object is and what is essentially useless information or garbage.

It is during data intake from all the sensors at shooting time, that the system is pattern matching. However, in order to keep the system flowing or operating without error, the system is attempting to pattern match the entire facility at all times. It is correlating live sensor data (e.g., 2D and 3D camera data) from the shoot with data from the world timeline table and object tables. In this manner, when sensor data streamed into the system represents a relevant 3D object, such as a soda can or laptop, it will know from matching the raw data representing the soda can with data from the object table and timeline. The timeline data tells the system that at this time (in the scene), expect to see a soda can. It can then correlate the otherwise meaningless sensor data with data from the timeline and object tables. From this correlation or pattern matching it can conclude that the sensor data is in fact a soda can. By virtue of this correlation, the timeline may be described as essentially optimizing data captured and sensed during production. For example, during production when the system sees a cup or a laptop, it will know from the world timeline, which contains all the descriptor data described above, that the system should expect to see a specific object. It is because of this real-time pattern matching between what is being shot on stage and what is expected according to the script that the system needs to have detailed data on all the relevant 3D objects. The system knows what objects, actors, and actions take place in each scene during production. This is an important feature of the system because the video stream to each user or group of users (i.e., the individualized streams) is created in real time during production. In one embodiment, the system is capturing data constantly during production. For example, sensors may keep track of actors during production, even when not filming a scene, so it knows where all the actors are in the environment, specifically in the production facility. This practice is useful in keeping everything streamlined and efficient.

When shooting is complete, which coincides with completion of the timeline, the system has a traditional video sequence and the metadata, consisting of timelines and object tables.

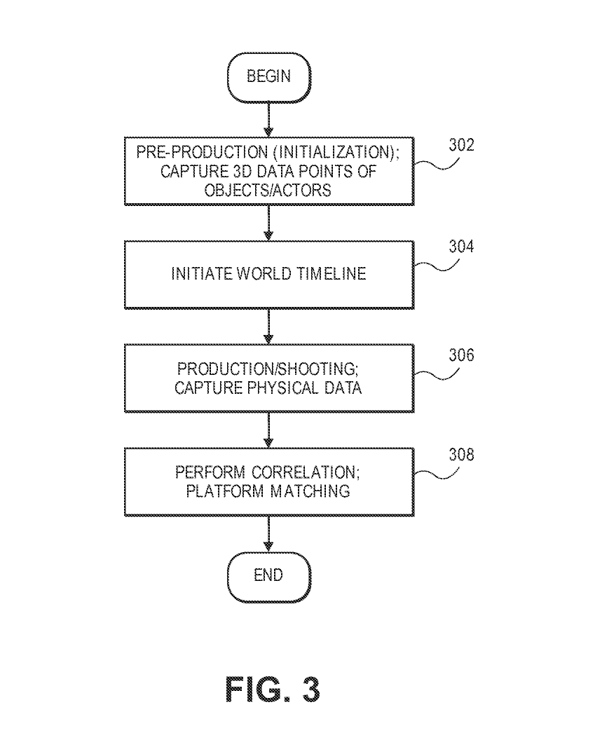

FIG. 3 is a flow diagram of what may be described as pre-production followed by production of individualized video content streams in accordance with one embodiment. The flow diagram provides an overview of the detailed processes described above. At step 302 objects and actors are initialized in the system (in part to maintain object constancy). All 3D data points of objects and actors are captured using a wide array of sensors, typically on a stage where the scenes will be shot. The goal is to capture the electro-magnetic spectrum, the environment in which the scenes take place on stage. At step 304 a world clock, one of the required steps in the actual production of the video content, is initiated and synchronization begins. At step 306 which is essentially concurrent with step 304, shooting begins on one or more stages equipped with a variety of sensors for capturing the electro-magnetic spectrum. At this production step, the environment and the performances of the actors, also characterized as the electro-magnetic/physical data comprising the scenes, are captured. At step 308, also concurrent with step 306 and performed while the world clock is running (and therefore enabling synchronization), the system performs the critical step of correlation, also referred to as pattern matching. This step, described in detail above, matches objects and actors on stage that are being shot (captured data) with what is expected in that scene as dictated by the 3D rules set data created by the creation tool and script described in FIG. 1. What is being done at step 308 is that the system is building a representative 3D world with the captured data (i.e., the data obtained at shooting).

The output content stream with embedded product placement is rendered on the users' viewers. In one embodiment, this is done by a rendering engine. The engine examines the viewer database storing hardware and software platform data for various viewers. The engine also examines user profiles and uses data from both these sources, as well as the vendor profiles to determine the output data stream of the video to be delivered to a specific user and to be rendered on a certain viewer device. The 3D creation rules are interpreted as a pre-cursor to rendering. The 3D creation rules inform the rendering engine what the engine will be processing (i.e., essentially what it will be seeing). In another embodiment, the viewer swaps out the objects or modular content with other objects.

The system may be characterized as an adaptive rendering system. For example, a viewer may be a mobile phone. A mobile phone does not have much in way of a GPU (graphics processing unit) and bandwidth of the network connection to the phone is limited. As such, the delivered content stream to the phone should be a compressed data stream that only needs to be displayed to the user. In this instance the output stream is rendered somewhere other than on the user's mobile phone. The rendering should take place at any point in the network except for on the phone. The rendering may be aided by the user's home computer, a host server, or another user's device in an anonymous and non-intrusive way. In another example, a viewer may be a home computer having a GPU that can render some of the inserted elements on its own, thus the 3D geometry, textures, and lighting instructions are sent with the video stream and the home computer renders the modular elements and composites them on the viewer (home computer) itself. In this context, an element is something that could be described as a collection of objects; an element layer might be comprised of a few objects. In another example, the viewer is a laptop that has a weak GPU but can do 2D compositions. Multiple video streams might be sent to the laptop for simple composition, in contrast to a final output stream as was done with the mobile device. Each of these examples would deliver a user-centric stream, but data processing is offset in an adaptive way to maximize utilization of the viewer hardware/software platform.

In one embodiment, determining what to render on a user's viewer device can be characterized as deciding which 3D objects to swap out of the video content. For example, a scene may have a laptop computer as a product placement candidate. For user A, viewing the content on an iPhone, rendering will take into account the user's preferences, demographics, and viewer and compresses the stream using a suitable algorithm for the handheld device and displaying an Apple laptop. For user B who uses Samsung products, viewing the content on an HDTV, rendering will take into account his preferences and display a Samsung laptop in the scene and will be rendered such that it takes advantage of a full-screen HDTV. As is evident from these two basic examples, there can be many variations for rendering, given that there are numerous hardware and software platform options for viewer devices (smart phone, tablet, laptop, game console, TV, and so on) and their different manufactures. Each device class has its own processing capabilities (with some devices sharing the same capabilities) and, in one embodiment, the output video stream to the device may contain a video stream and metadata suitable for that device's platform.

Variations for user preferences and profiles, of course, are nearly limitless. As noted throughout, rendition of the video content is individualized for the specific user and takes into account the specific viewer being used (a user may multiple devices on which she watches the content). After the system determines what to render for a specific user and viewer, the video sequence and the metadata, the output stream, is transmitted to the viewer where it is rendered.

As described above, an important feature of the present invention is the ability to modularize product placement objects at the time of production for n users. User preferences, whether product related or otherwise, are embedded in the video output stream and received by the device. In this manner, the final product, such as the TV show or movie, is always changing because it is being customized for each user while it is being produced (shot). As shown, there are numerous types of data captured and “sensed” resulting in voluminous data relating to the video content that is not captured using conventional digital video production. This data enables the system to understand what is being captured during production and make decisions on what to swap or modularize “on the spot.”

In another embodiment, the video is composed and rendered on the viewer based on data sent to it from the system. Rendering of the video content in this embodiment takes into account a viewer device profile, namely the hardware and software platform of the device. For example, one notable hardware feature of a device is whether it has a front-facing camera. As described below, this feature can be used to enhance user profiles, provide rapid feedback to vendors and the operator about user preferences, and can be used to implement features of unconscious learning.

Embodiments of the present invention may be utilized in various environments and use cases that involve audio/video content. One is in the field of education, specifically in the area of “unconscious learning.”

In another embodiment of the present invention, a Quantum Neural Feedback Predictive and Reactive Algorithm is utilized. First, two definitions are provided:

FIRE=executed in the clock pass

STATE=on/off/random

The system uses a two-tier neural network for object data analysis. The first part of the neural network is the utilization of weighted inputs and outputs. For example, not every process is executed on every clock cycle. This means that even if a process is wired to go, it will not “fire” unless it hits the proper “state”, as these terms are defined above.

Referring now to FIG. 4, every process or instruction set 404 in the system can be considered a node that contains a STATE 406. STATE 406 has three options: ON, OFF, or RANDOM. When a node 402 is ON it has passed the predefined criteria for being used in that clock pass and will be executed. When node 402 is OFF it does not pass the criteria for firing. If state 406 is OFF, it then falls to a RANDOM state which in rare instances, based on a random number generator, will actually turn state 406 to ON. This is to simulate chaos in the system and things that can result as fortuitous.

The structure of these nodes is node[input[ ] 408, predictedResult[ ] 410, process[ ] 404, threshold int, state 406 [on, off, random( )], and output[ ] 412]. As a result of this structure each node 402 may be described as its own CPU, handling when, how, and what to do with processed data 412.

For example, node 402 may be processing the data from an eye tracking test. The system is instructed to insert a stimuli at (x,y) on the screen and track the iris movement of the user. It is then instructed to only execute after n samples are collected. Every node 402 contains a predictedResult[ ] 410 that may be garbage or is a calculated coloration from the previous iteration. This eye tracking node at sample 1 will have a value in predictedResult[ ] 410 from the prior instance, or will have a generic value based on the default. If n number of samples does not meet the FIRE criteria (defined above), the system state 406 is OFF and thus also RANDOM. If by chance after x<n and random is triggered and the predictedResult 410==output 412, the n for required samples is adjusted to now reflect x, as fewer samples were needed to gain the desired result. This works in the inverse as well, where if predictedResult 410=!output 412, the required samples are increased to help the system gain enough information for the next cycle to accurately predict the result.

The quantum element of the system is predictedResult 410. The predictedResults data 410 are calculated on a number of vectors. Data in the first predictedResult 410 uses the previous data model to predict the next logical iteration of the data. The second predictedResult is the inverse of the logical iteration, i.e., if x in the logical prediction is 1, the x in the second predicted result is −1. The system will also calculate other vectors as well that could be variable outputs. For example, reflectance is a tangent equation, thus, the data is not X or −X, but a reverse of Y and continuation of X. The predictedResult 412 will try as many iterations as it can between processes to allow for a quick switch. Each predictedResult 412 will store the data for itself and how it affects the model. This may be referred to as a pre-calculation. Once the observed data is calculated, it is compared to predictedResults 410 and if the prediction is close enough to the actual, the system does not need to calculate through the data, as this has been done in the pre-calculation. It only needs to switch the connected data node instead of loading the data into a new storage space.

In the described embodiment, the system also includes a re-light module which enables integration and alteration of objects while maintaining the desired lighting composition in the scene. As is known in the art, 2D-based systems do not record depth or 3D information of a scene. Thus, the addition or subtraction on lights, shadows, and related lighting effects is typically only achievable through an artist's rendition or though other non-automated processes. The system of the present invention records the 3D data and therefore it is able to automate the addition or subtraction of light because it can effectively re-trace shadows and lights and have them interact with 3D data stored in the system in an accurate way.

For example, a scene showing an actor's head (or any other object) in video shot using a 2D camera is a collection of (x,y) points with pixel color data. This collection of x, y coordinates does not define any information that would be needed for re-lighting of the actor's head or other object. As described above, the system of the present invention is recording the 3D position of each pixel, therefore it can insert a virtual light into the scene and see how a shadow (or any other lighting effect) would cast on the head. This is important because, for example, when the system adds a product for product placement in a scene, it will need to occlude and cast shadows on the environment, otherwise the scene will not look realistic; it may have the undesirable look of having a magazine picture pasted onto the video. The re-light could be a rendering of a complete scene, a render of a single object or collection of objects, or what is referred to as a pass render (shadow, luminance, highlight, etc.). The only requirement for these effects to be integrated into a scene is that they be rendered from the same angle as the rendered/output camera, that is, the camera angle selected for the broadcast at any given moment.

As shown above, one embodiment of the present invention is in the context of product placement in connection with motion picture, television, internet, and other video content technology. For the purpose of explaining the invention and providing an embodiment that is enabling of the invention, the product placement use case is used as an illustration and as the described embodiment above. The product placement use case provides a good example of how the invention can be used and one that is both familiar and immediately practical. The concepts, flows, processes, and formats provided for enabling the described embodiment of the invention may be used in many other use cases, including education and unconscious learning.

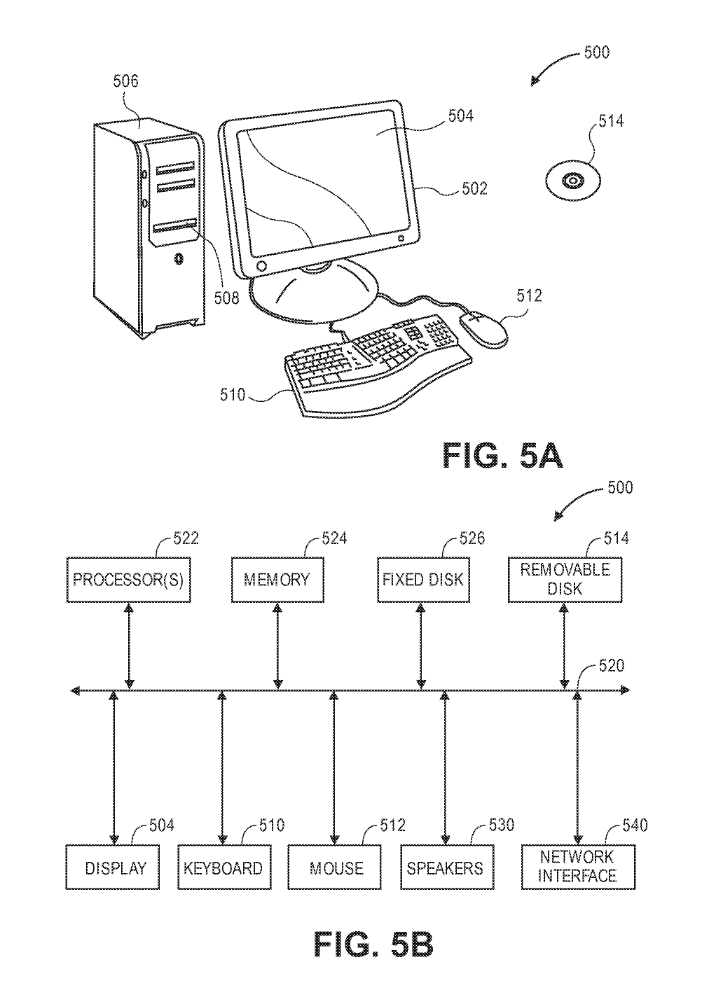

FIGS. 5A and 5B illustrate a computing system 500 suitable for implementing embodiments of the present invention. FIG. 5A shows one possible physical form of the computing system. Of course, the computing system may have many physical forms including an integrated circuit, a printed circuit board, a small handheld device (such as a mobile telephone, handset or PDA), a personal computer or a super computer. Computing system 500 includes a monitor 502, a display 504, a housing 506, a disk drive 508, a keyboard 510 and a mouse 512. Disk 514 is a computer-readable medium used to transfer data to and from computer system 500.

FIG. 5B is an example of a block diagram for computing system 500. Attached to system bus 520 are a wide variety of subsystems. Processor(s) 522 (also referred to as central processing units, or CPUs) are coupled to storage devices including memory 524. Memory 524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 526 is also coupled bi-directionally to CPU 522; it provides additional data storage capacity and may also include any of the computer-readable media described below. Fixed disk 526 may be used to store programs, data and the like and is typically a secondary storage medium (such as a hard disk) that is slower than primary storage. It will be appreciated that the information retained within fixed disk 526, may, in appropriate cases, be incorporated in standard fashion as virtual memory in memory 524. Removable disk 514 may take the form of any of the computer-readable media described below.

CPU 522 is also coupled to a variety of input/output devices such as display 504, keyboard 510, mouse 512 and speakers 530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 522 optionally may be coupled to another computer or telecommunications network using network interface 540. With such a network interface, it is contemplated that the CPU might receive information from the network, or might output information to the network in the course of performing the above-described method steps. Furthermore, method embodiments of the present invention may execute solely upon CPU 522 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What we claim is:

1. A method of placing products in a video content, the method comprising:
analyzing a script for the video content;
creating 3D rule set data from the script;
creating an object source file from the script containing data on 3D objects in the script;
examining one or more vendor profiles;
initializing 3D objects in the script;
shooting the video content with multiple sensors;
correlating data captured from shooting the script with the 3D rule set data; and
creating an individualized video content stream for a specific user watching the video content on a specific viewing device.

2. A method as recited in claim 1 wherein the script contains temporal relationships of 3D objects and actions taken by actors.

3. A method as recited in claim 1 wherein creating an object source file from the script further comprises:
digitizing 3D objects in the script; and
describing 3D object using object descriptors.

4. A method as recited in claim 1 wherein shooting the script with multiple sensors further comprises:
utilizing one or more stages equipped with said multiple sensors; and
capturing the electro-magnetic spectrum of action occurring on the one or more stages.

5. A method as recited in claim 1 further comprising:
selecting products from the one or more vendor profiles to be shown in the video content.

6. A method as recited in claim 1 wherein the individualized video content stream is created at time of shooting the video content.

7. A method as recited in claim 1 wherein each 3D rule set data represents a scene in the script.

8. A method as recited in claim 1 wherein a vendor profile contains vendor product data and vendor user preference data.

9. A method as recited in claim 1 further comprising:
identifying product placement opportunities in the script.

10. A method as recited in claim 1 wherein correlating data captured from shooting the script is performed at the time of shooting.

11. A method of creating an individualized video content stream containing product placement for a specific user, the method comprising:
entering a script into a database;
identifying objects and temporal relationships in the script;
digitizing physical objects in the script to obtain 3D data points and texture data;
creating fixed world data from 3D data points, texture data, and other script data;
shooting the script thereby creating a video stream;
correlating the video stream with the fixed world data; and
inserting product placement objects into the video stream using a user profile and a vendor profile.

12. A method as recited in claim 11 further comprising:
classifying objects using standardized descriptors.

13. A method as recited in claim 11 wherein entering a script into a database further comprises:
using a timeline creation tool for creating multiple timelines.

14. A method as recited in claim 11 wherein correlating the video stream with the fixed world data further comprises:
matching a pattern obtained during shooting the script with fixed world data.

15. A method as recited in claim 11 further comprising:
rendering the video stream on a viewing device; and
utilizing features of the viewing device to collect data on a user viewing the video stream, said features including a front-facing camera and said data including one or both of psychological data and physiological data of the user manifesting an emotional or physical response to the video stream, thereby enabling measurement of the effects of audio and visual elements of the video stream on the user.

16. A method of enabling product placement in a video content, the method comprising:
producing the video content based on a script;
correlating objects in the video content during production with previously acquired script data;
determining what brand of products a user prefers;
determining what type of user a product vendor wants to show its product;
determining a viewing device type with which the user will view the video content;
examining 3D objects in the video content before production;
modifying one or more 3D objects in the video content based on what products are available for placement in the video content and characteristics of the user; and
rendering the modified video content on the viewing device.

17. A method as recited in claim 16 wherein correlating objects in the video content further comprises:
determining whether an object being shot during production matches an object in the previously acquired script data.

18. A method as recited in claim 16 wherein determining what brand of product a user prefers further comprises examining a user profile.

19. A method as recited in claim 16 wherein determining what type of user a product vendor wants to show its product further comprises examining a vendor profile.

20. A method as recited in claim 16 further comprising:
upon rendering the modified video content on the viewing device, receiving data on the user viewing the modified video content, wherein said data includes one or both of psychological data and physiological data manifesting an emotional or physical response to the modified video content.
